(19) United States
(12) Patent Application Publication
(10) Pub. No.: US 2016/0316807 A1
(43) Pub. Date: Nov. 3, 2016

(54) ARRAY OF AGE-TAILORED INFANT FORMULA WITH OPTIMUM PROTEIN CONTENT AND LACTOSE CONTENT

(71) Applicant: NESTEC S.A., Vevey (CH)

(72) Inventors: Carlos Antonio De Castro, Geneva (CH); Yongcheng Liao, Beijing (CN); Celia Ning, Beijing (CN); Junkuan Wang, Beijing (CN); Ying Xia, Beijing (CN)

(21) Appl. No.: 15/103,955

(22) PCT Filed: Sep. 3, 2014
(86) PCT No.: PCT/EP2014/068675

§ 371 Date: Jun. 13, 2016

(30) Foreign Application Priority Data
Dec. 12, 2013 (CN) PCT/CN2013/089281

(51) Int. Cl. A23L 33/19; A23L 33/16; A23L 33/115; A23L 33/125; A23L 33/15; A23L 33/155; A23L 33/135; A23L 33/00; A23L 33/12

(52) U.S. Cl. CPC A23L 33/19; A23L 33/40; A23L 33/30; A23L 33/16; A23L 33/115; A23L 33/12; A23L 33/15; A23L 33/155; A23L 33/135; A23L 33/125; A23V 2002/00; A23Y 2300/49; A23Y 2300/55

(57) ABSTRACT

The present invention relates to an array of infant formula for providing an age-tailored nutrition system to an infant, it comprises a first infant formula between 0 to 3 months, a second infant formula between 3 to 6 months, and an optional third infant formula between 6 to 12 months, wherein the content of protein in the second infant formula is lower than in the first infant formula; the content of lactose in the second infant formula is higher than in the first infant formula; the content of protein in the optional third infant formula is lower than in the second infant formula; and the content of lactose in the optional third infant formula is higher than in the second infant formula array of infant formula for providing an age-tailored nutrition system to an infant comprising a first infant formula between 0 to 3 months and a second infant formula between 3 to 6 months, wherein the content of protein in the second infant formula is lower than in the first infant formula; and the content of lactose in the second infant formula is higher than in the first infant formula. The array of the invention also relates to its preparation method and uses.

### FIELD OF THE INVENTION

The present invention relates to an array of infant formula which are specifically designed to address the needs of infants between 0 and 6 months, especially between 0 to 3 months, optionally between 6 to 12 months. In particular, the invention provides an array of infant formula for infants between 0 and 6 months, especially between 0 to 3 months, optionally between 6 to 12 months, each infant formula having age-specific protein content and lactose content.

### BACKGROUND OF THE INVENTION

The composition of the human milk varies naturally according to the age of the infant. Such variations affect not only the overall energy density but also greatly affect the relative infant formula of the milk in the diverse nutrients. For example, the protein content and lactose content of human breast milk varies during breastfeeding according to the age of the infant, especially the age of the infant between 0 and 6 months. So far however the exact composition of human breast milk and its evolution over time remains an area of dispersed knowledge and of some conflicting information.

It is therefore important to develop infant formula which replicates human breast milk in terms of nutritional properties.

Infant formula, follow-up formula and grown-up milks which are aimed at different age groups of 0 to 6 months, 6 months to 12 months, and 12 months to 3 years respectively are well known. These formulas aim to meet the requirements of infants and young children at the different ages.

An age-tailored nutrition system for infants is described in WO 2009/068549, wherein the protein nature and content are adapted to specific age groups.

However, there is still a need to develop an array of infant formula which replicates human breast milk in more fine divided phases, especially human breast milk between to 3 months and from 3 months to 6 months as far as possible in terms of nutritional properties.

There is especially a need to develop an array of such infant formula that correspond specifically to the need of some particular population.

### OBJECT OF THE INVENTION

It is an object of the invention to follow the nutritional evolution curve of human breast milk between 0 to 6 months, especially human breast milk between 0 to 3 months.

### SUMMARY OF THE INVENTION

Thus, in one aspect, the invention provides an array of infant formula for providing an age-tailored nutrition system to an infant, it comprises a first infant formula between 0 to 3 months, a second infant formula between 3 to 6 months, and an optional third infant formula between 6 to 12 months, wherein

the content of protein in the second infant formula is lower than in the first infant formula;

the content of lactose in the second infant formula is higher than in the first infant formula;

the content of protein in the optional third infant formula is lower than in the second infant formula; and the content of lactose in the optional third infant formula is higher than in the second infant formula.

In another one aspect, the invention provides a method of providing nutrition to an infant, comprising:

(i) feeding to the infant for initial three months of life the first infant formula,

(ii) feeding to the infant for the remainder of the first six months of life the second infant formula, and optionally

(iii) feeding to the infant for the remainder of the first twelve months of life the optional third infant formula.

In still another aspect, the invention provides use of the array of infant formula in reducing obesity or diabetes or the risk thereof later in life, or in reducing cardiovascular diseases or the risk thereof later in life.

The invention may be targeted, in another aspect, to some particular groups of populations that have similar or related dietary and/or genetic background (for example such as the Chinese population).

### DETAILED DESCRIPTION OF THE INVENTION

In the present specification, the following words are given a definition that must be taken into account when reading and interpreting the description, examples and claims.

Infant: according to the Commission Directive 91/321/EEC of 14 May 1991 on infant formula and follow-on formula, article 1.2 (a), the term “infants” means children under the age of 12 months. This definition is adopted in the present specification.

The term “infant formula” means foodstuffs intended for particular nutritional use by infants and satisfying by themselves the nutritional requirements of this category of persons. It has to be understood that infants can be fed solely with infant formula, or that the infant formula can be used by the carer as a complement of human milk.

Probiotic: according to the paper Probiotics in Man and Animals, J. Appl Bacteriol. 66: 365-378, a probiotic is defined as a live microbial feed supplement which beneficially affects the host animal by improving its intestinal microbial balance.

In order to mimic human breast milk, we carried out an investigation in China to characterize the nutrients composition of Chinese mother milk. Some results of protein, lactose, fat, energy density and mineral nutrients in our statistical report of breast milk of Chinese lactating mothers are briefly provided below.

Study Design

This is an observational, cross sectional, multi-center study aiming at evaluating nutrients composition of breast milk and nutrition intake of Chinese lactating mothers in 3 cities in China.

Study Population

Number of subjects

Total 540 healthy subjects were enrolled, allowing a drop-out rate of 10 percent. They were comprised of:

480 Lactating mothers in 3 cities (Beijing, Suzhou and Guangzhou)

30 mothers per city for each of the 5 time points (5-11 days, 1 month, 2 months, 4 months and 8 months)

Inclusion/Exclusion criteria

Inclusion: Healthy Chinese lactating mothers without history of acute and chronic diseases; exclusively breast feeding mothers during 4 months after delivery were enrolled.

Exclusion: Chinese lactating mothers having history of psychopath tendencies and having no dietary memory.

Results

Summary statistics of Minerals

| | | | | | |
|---|---|---|---|---|---|
| months | N | Min | Mean | SD | Max |

Energy density
(kcal/100 ml)

| | | | | | |
|---|---|---|---|---|---|
| 0 | 86 | 38.00 | 58.58 | 10.42 | 89.0 |
| 1 | 88 | 38.00 | 64.03 | 12.20 | 98.0 |
| 2 | 90 | 29.00 | 62.26 | 14.19 | 99.0 |
| 4 | 90 | 33.00 | 58.01 | 13.28 | 94.0 |
| 8 | 89 | 25.00 | 58.66 | 14.15 | 96.0 |

Fat (g/100 ml)

| | | | | | |
|---|---|---|---|---|---|
| 0 | 86 | 0.70 | 2.87 | 1.10 | 6.2 |
| 1 | 88 | 0.90 | 3.59 | 1.35 | 7.3 |
| 2 | 90 | 0.20 | 3.48 | 1.58 | 7.9 |
| 4 | 90 | 0.60 | 3.09 | 1.44 | 7.2 |
| 8 | 89 | 0.50 | 3.18 | 1.56 | 7.6 |

Lactose (g/100 ml)

| | | | | | |
|---|---|---|---|---|---|
| 0 | 86 | 5.00 | 6.76 | 0.51 | 7.9 |
| 1 | 88 | 5.60 | 6.98 | 0.38 | 7.7 |
| 2 | 90 | 6.00 | 7.16 | 0.29 | 7.8 |
| 4 | 90 | 6.20 | 7.23 | 0.31 | 8.0 |
| 8 | 89 | 6.60 | 7.28 | 0.33 | 8.2 |

Protein (g/100 ml)

| | | | | | |
|---|---|---|---|---|---|
| 0 | 86 | 0.60 | 1.32 | 0.34 | 2.3 |
| 1 | 88 | 0.20 | 1.06 | 0.22 | 1.9 |
| 2 | 90 | 0.50 | 0.90 | 0.15 | 1.4 |
| 4 | 90 | 0.10 | 0.80 | 0.12 | 1.1 |
| 8 | 89 | 0.20 | 0.77 | 0.15 | 1.3 |

Calcium (mg/kg)

| | | | | | |
|---|---|---|---|---|---|
| 0 | 90 | 192.00 | 303.32 | 52.45 | 419.00 |
| 1 | 90 | 151.00 | 293.16 | 46.27 | 397.00 |
| 2 | 90 | 206.00 | 309.27 | 42.99 | 432.00 |
| 4 | 90 | 198.00 | 287.44 | 39.99 | 406.00 |
| 8 | 90 | 150.00 | 267.59 | 43.43 | 462.00 |

Copper (mg/kg)

| | | | | | |
|---|---|---|---|---|---|
| 0 | 90 | 0.16 | 0.56 | 0.15 | 0.93 |
| 1 | 89 | 0.26 | 0.49 | 0.14 | 1.10 |
| 2 | 90 | 0.15 | 0.35 | 0.09 | 0.59 |
| 4 | 90 | 0.13 | 0.31 | 0.07 | 0.47 |
| 8 | 86 | 0.11 | 0.28 | 0.09 | 0.64 |

Iodine (μg/kg)

| | | | | | |
|---|---|---|---|---|---|
| 0 | 89 | 53.00 | 293.63 | 157.29 | 946.00 |
| 1 | 89 | 62.00 | 223.35 | 121.47 | 618.00 |
| 2 | 85 | 51.00 | 188.09 | 91.33 | 680.00 |
| 4 | 88 | 51.00 | 175.28 | 75.99 | 484.00 |
| 8 | 90 | 59.00 | 185.96 | 96.35 | 594.00 |

Phosphorus (mg/kg)

| | | | | | |
|---|---|---|---|---|---|
| 0 | 90 | 66.00 | 143.79 | 33.64 | 214.00 |
| 1 | 90 | 73.00 | 147.88 | 24.64 | 228.00 |
| 2 | 90 | 93.00 | 136.08 | 19.48 | 182.00 |
| 4 | 90 | 88.00 | 118.02 | 18.39 | 192.00 |
| 8 | 90 | 35.00 | 113.58 | 19.45 | 198.00 |

Potassium (mg/kg)

| | | | | | |
|---|---|---|---|---|---|
| 0 | 90 | 438.00 | 665.89 | 111.00 | 1001.00 |
| 1 | 90 | 423.00 | 600.34 | 79.03 | 832.00 |
| 2 | 90 | 375.00 | 537.10 | 63.30 | 715.00 |
| 4 | 90 | 352.00 | 489.12 | 61.36 | 649.00 |
| 8 | 90 | 356.00 | 459.26 | 47.94 | 614.00 |

Sodium (mg/kg)

| | | | | | |
|---|---|---|---|---|---|
| 0 | 89 | 8.70 | 36.28 | 22.57 | 122.00 |
| 1 | 89 | 9.70 | 23.77 | 19.09 | 128.00 |
| 2 | 90 | 6.00 | 14.30 | 6.75 | 51.00 |
| 4 | 90 | 4.10 | 13.26 | 6.88 | 45.00 |
| 8 | 90 | 3.90 | 12.05 | 9.24 | 81.00 |

Zinc (mg/kg)

| | | | | | |
|---|---|---|---|---|---|
| 0 | 90 | 0.89 | 3.87 | 1.52 | 9.90 |
| 1 | 90 | 0.91 | 2.85 | 1.16 | 7.30 |
| 2 | 90 | 0.66 | 1.98 | 0.68 | 4.10 |
| 4 | 89 | 0.52 | 1.47 | 0.61 | 3.50 |
| 8 | 86 | 0.57 | 1.25 | 0.50 | 2.90 |

According to above results, the inventors performed statistical analysis and surprisingly found: (1) the contents of protein and energy density in breast milk gradually decrease and the content of lactose gradually increases in the first 12 months, especially in the first 6 months; and (2) the contents of many mineral nutrients in breast milk gradually decrease in the first 12 months, especially in the first 6 months. Moreover, the ratio of calcium and phosphorus gradually increase in this period. Based on these unexpected findings, the present invention provides modified contents of protein, lactose, mineral nutrients in infant formula to improve nutritional condition of an infant.

Thus, in one embodiment of the invention, the invention provides an array of infant formula for providing an age-tailored nutrition system to an infant, it comprises a first infant formula between 0 to 3 months, a second infant formula between 3 to 6 months, and an optional third infant formula between 6 to 12 months, wherein

the content of protein in the second infant formula is lower than in the first infant formula;

the content of lactose in the second infant formula is higher than in the first infant formula;

the content of protein in the optional third infant formula is lower than in the second infant formula; and

the content of lactose in the optional third infant formula is higher than in the second infant formula.

In one embodiment of the invention, the invention provides an array of infant formula, wherein

said first infant formula comprises a protein content of between 1.9 and 2.9 g/100 kcal, preferably between 2.2 and 2.7 g/100 kcal, more preferably between 2.4 and 2.6 g/100 kcal and a lactose content of between 9.2 and 13.8 g/100 kcal, preferably between 10.5 and 12.6 g/100 kcal, more preferably between 11.3 and 11.9 g/100 kcal of the first infant formula,

said second infant formula comprises a protein content of between 1.9 and 2.9 g/100 kcal, preferably between 2.1 and 2.6 g/100 kcal, more preferably between 2.3 and 2.5 g/100 kcal and a lactose content of between 9.2 and 13.8 g/100 kcal,

preferably between 10.3 and 12.5 g/100 kcal, more preferably between 11.1 and 11.6 g/100 kcal of the second infant formula, and

said optional third infant formula comprises a protein content of between 1.9 and 2.9 g/100 kcal, preferably between 2.0 and 2.5 g/100 kcal, more preferably between 2.2 and 2.4 g/100 kcal and a lactose content of between 9.2 and 13.8 g/100 kcal, preferably between 10.2 and 12.4 g/100 kcal, more preferably between 11.0 and 11.5 g/100 kcal of the optional third infant formula.

In one embodiment of the invention, the invention provides an array of infant formula, wherein the energy density in the second infant formula is lower than in the first infant formula, and the energy density in the optional third infant formula is lower than in the second infant formula, and

said first infant formula comprises a energy density of between 63 and 67 kcal/100 ml, preferably between 65 and 66 kcal/100 ml,

said second infant formula comprises a energy density of between 63 and 67 kcal/100 ml, preferably between 64 and 65 kcal/100 ml, and

said optional third infant formula comprises a energy density of between 63 and 65 kcal/100 ml, preferably between 64 and 65 kcal/100 ml.

In one embodiment of the invention, the invention provides an array of infant formula, wherein

said first infant formula comprises a fat content of between 4.4 and 5.8 g/100 kcal, preferably between 4.8 and 5.3 g/100 kcal, more preferably between 5.0 and 5.2 g/100 kcal of the first infant formula,

said second infant formula comprises a fat content of between 4.4 and 5.8 g/100 kcal, preferably between 4.7 and 5.4 g/100 kcal, more preferably between 4.9 and 5.2 g/100 kcal of the second infant formula, and

said optional third infant formula comprises a fat content of between 4.4 and 5.8 g/100 kcal, preferably between 4.6 and 5.3 g/100 kcal, more preferably between 4.8 and 5.3 g/100 kcal of the optional third infant formula.

In one embodiment of the invention, the invention provides an array of infant formula,

wherein each of said first, second and optional third infant formula comprises suitable amounts of mineral nutrients selected from the group consisting of calcium, iodine, phosphorus, potassium, sodium, copper and zinc,

wherein the content of at least one of said mineral nutrients in the second infant formula is lower than in the first infant formula, and the content of said at least one mineral nutrient in the optional third infant formula is lower than in the second infant formula.

In one embodiment of the invention, the invention provides an array of infant formula, wherein the contents of at least two, preferably at least three, more preferably at least four, particularly preferably at least five of said mineral nutrients in the second infant formula are lower than in the first infant formula, and the contents of said at least two, preferably at least three, more preferably at least four, particularly preferably at least five of said mineral nutrients in the optional third infant formula are lower than in the second infant formula.

In one embodiment of the invention, the invention provides an array of infant formula, wherein the contents of iodine, phosphorus, potassium, sodium, copper and zinc in the second infant formula are lower than in the first infant formula, and the contents of said mineral nutrients in the optional third infant formula are lower than in the second infant formula.

In one embodiment of the invention, the invention provides an array of infant formula, wherein the contents of calcium, iodine, phosphorus, potassium, sodium, copper and zinc in the second infant formula are lower than in the first infant formula, and the contents of said mineral nutrients in the optional third infant formula are lower than in the second infant formula.

In one embodiment of the invention, the invention provides an array of infant formula, wherein the content of iodine in the first infant formula is from 50.0 μg/100 kcal to 16.5 μg/100 kcal, preferably from 25.0 μg/100 kcal to 16.5 μg/100 kcal, the content of iodine in the second infant formula is from 16.5 μg/100 kcal to 14.0 μg/100 kcal, and the content of iodine in the optional third infant formula is lower than 14.0 μg/100 kcal.

In one embodiment of the invention, the invention provides an array of infant formula, wherein the content of phosphorus in the first infant formula is from 70 mg/100 kcal to 42 mg/100 kcal, preferably from 52 mg/100 kcal to 42 mg/100 kcal, the content of phosphorus in the second infant formula is from 42 mg/100 kcal to 38 mg/100 kcal, and the content of phosphorus in the optional third infant formula is lower than 38 mg/100 kcal.

In one embodiment of the invention, the invention provides an array of infant formula, wherein the content of potassium in the first infant formula is from 170 mg/100 kcal to 85 mg/100 kcal, preferably from 118 mg/100 kcal to 85 mg/100 kcal, the content of potassium in the second infant formula is from 85 mg/100 kcal to 80 mg/100 kcal, and the content of potassium in the optional third infant formula is lower than 80 mg/100 kcal.

In one embodiment of the invention, the invention provides an array of infant formula, wherein the content of sodium in the first infant formula is from 58 mg/100 kcal to 25 mg/100 kcal, preferably from 51 mg/100 kcal to 25 mg/100 kcal, the content of sodium in the second infant formula is from 25 mg/100 kcal to 22 mg/100 kcal, and the content of sodium in the optional third infant formula is lower than 22 mg/100 kcal.

In one embodiment of the invention, the invention provides an array of infant formula, wherein the content of copper in the first infant formula is from 120 μg/100 kcal to 62 pg/100 kcal, preferably from 109 μg/100 kcal to 62 pg/100 kcal, the content of copper in the second infant formula is from 62 μg/100 kcal to 55 μg/100 kcal, and the content of copper in the optional third infant formula is lower than 55 μg/100 kcal.

In one embodiment of the invention, the invention provides an array of infant formula, wherein the content of zinc in the first infant formula is from 1.5 mg/100 kcal to 0.7 mg/100 kcal, the content of zinc in the second infant formula is from 0.7 mg/100 kcal to 0.6 mg/100 kcal, and the content of zinc in the optional third infant formula is lower than 0.6 mg/100 kcal.

In one embodiment of the invention, the invention provides an array of infant formula, wherein the content of calcium in the first infant formula is from 140 mg/100 kcal to 98 mg/100 kcal, preferably from 108 mg/100 kcal to 98 mg/100 kcal, the content of calcium in the second infant formula is from 98 mg/100 kcal to 95 mg/100 kcal, and the content of calcium in the optional third infant formula is lower than 95 mg/100 kcal.

In one embodiment of the invention, the invention provides an array of infant formula, wherein the ratio of calcium and phosphorus in the first infant formula is lower than in the second infant formula, and the ratio of calcium and phosphorus in the second infant formula is lower than in the optional third infant formula.

In one embodiment of the invention, the invention provides an array of infant formula, wherein the ratio of calcium and phosphorus in the first infant formula is from 2.0:1 to 2.2:1, preferably from 2.1:1 to 2.2:1.

In one embodiment of the invention, the invention provides an array of infant formula, wherein the ratio of calcium and phosphorus in the second infant formula is from 2.2:1 to 2.4:1.

In one embodiment of the invention, the invention provides an array of infant formula, wherein the ratio of calcium and phosphorus in the optional third infant formula is from 2.4:1 to 2.5:1.

In one embodiment of the invention, the invention provides an array of infant formula, wherein each of the first, the second and the optional third infant formula comprises long-chain polyunsaturated fatty acids selected from docosahexaenoic acid (DHA), arachidonic acid (ARA), or eicosapentaenoic acid (EPA), and/or comprises medium-chain triglycerides and/or milk fat globule membranes (MFGM), or any mixtures thereof.

In one embodiment of the invention, the invention provides an array of infant formula, wherein each of the first, the second and the optional third infant formula comprises vitamins, lactoferrin, probiotics, prebiotics, proteins associated with milk fat globule membrane (MFGM), hydrolysed or non-hydrolysed protein, carbohydrates, maltodextrin, or any mixtures thereof.

In one embodiment of the invention, the invention provides an array of infant formula, wherein the probiotics in the first and second infant formula are selected from the list comprising L. helveticus CNCM 1-4095, B. longum CNCM I-2618, B. breve NCC2950, L. paracasei ST11 CNCM 1-2116, B. longum BB536 ATCC BAA-999, B. Longum BL999, L. acidophilus L92 FERM BP.4981 or any mixtures thereof, preferably in an amount of 10⁴-10⁷ cfu/g, most preferably 10⁶cfu/g.

In one embodiment of the invention, the invention provides an array of infant formula, wherein the probiotics in the optional third infant formula are selected from the list comprising B. longum CNCM 1-2618, B. breve CNCM 1-3865, B. lactis CNCM 1-3446, B. longum ATCC BAA-999 (Bb536), L. lactis SL31 CNCM 1-4154, L. paracasei ST11 CNCM 1-2116 or any mixtures thereof, preferably in an amount of 10⁶-10⁸ cfu/g, most preferably 10⁷ cfu/g.

In one embodiment of the invention, the invention provides an array of infant formula, wherein the first infant formula has a protein source comprising whey and optionally casein proteins and has a whey:casein ratio between 100:0 and 60:40 and a protein content between 1.9 and 2.9 g protein/100 kcal, and the second infant formula has a protein source comprising whey and casein proteins and has a whey:casein ratio between 70:30 and 50:50 and a protein content between 1.9 and 2.9 g protein/100 kcal with the proviso that either the protein content or the whey:casein ratio of the second formula or both is/are lower than for the first formula.

In one embodiment of the invention, the invention provides an array of infant formula, wherein each of the first, the second and the optional third infant formula are in the form of a powder to be reconstituted or a concentrate to be diluted.

In one embodiment of the invention, the invention provides an array of infant formula, wherein the first, the second and the optional third infant formula are packed in single dose units, each unit comprising sufficient nutritional composition to prepare a single serving upon reconstitution with water.

In one embodiment of the invention, the invention provides an array of infant formula, wherein the single dose units are in a form of a capsule or a can.

In one embodiment of the invention, the invention provides an array of infant formula for use in improving the nutritional condition of an infant from 0 to 6 months, especially from 0 to 3 months.

In one embodiment of the invention, the invention provides use of the array of infant formula for preparation of a kit for improving the nutritional condition of an infant from 0 to 6 months, especially from 0 to 3 months.

In one embodiment of the invention, the invention provides a method of providing nutrition to an infant, comprising:

(i) feeding to the infant for initial three months of life the first infant formula,

(ii) feeding to the infant for the remainder of the first six months of life the second infant formula, and optionally

(iii) feeding to the infant for the remainder of the first twelve months of life the third infant formula.

In one embodiment of the invention, the invention provides the array of infant formula for use in reducing obesity or diabetes or the risk thereof later in life.

In one embodiment of the invention, the invention provides the array of infant formula for use in reducing cardiovascular diseases or the risk thereof later in life.

The array of infant formula of the invention works in synergy such that optimal health effects are observed when the array of infant formula of the invention is used consequently.

Mimicking human breast milk to the best possible extent has been considered as a guidance as for the infant formula of the conventional infant at each individual age of the infant. However the array of infant formula of the invention allows to more closely follow the infant formula of human breast milk by proposing to have 2 individual ages between 0 to 6 months, i.e. one age between 0 to 3 months and another age between 3 to 6 months, whereas standard infant formula conventionally have one age between 0 to 6 months.

Also, the array of infant formula of the invention optimizes the protein, lactose and/or fat intake of the infants between 0 to 6 months. It has been hypothesized from on-going related studies that this optimization can relate to long term health benefits such as lower occurrence of infections, improved immune function and immune defenses, lower occurrence of allergies, better gut functions, better gut maturation, optimum growth, avoidance of over-weight later in life and/or better brain development.

It is hypothesized that the optimized fat intake over time allows not only for the best caloric intake and best fatty acids profile and intake (for example fatty acid that have been shown to relate to brain development), but also that the fat enables the transport and intake of lipo-soluble nutrients which play an important role in growth and development. The fat acts indeed as a carrier to lipo-soluble nutrients. As an illustration, providing an optimized fat content in the infant formula over a long period of time indirectly enhances the intake of lipo-soluble vitamins, or other nutrients (such as lipidic components of milk fat globule membranes) over an extended period of time.

The fat in the nutritional infant formula may be selected from milk and/or vegetable fat. Typical vegetable fats include palm olein, high oleic sunflower oil, high oleic safflower oil, canola oil, fish oil, coconut oil, bovine milk fat or any mixtures thereof.

Additionally, any of the infant formula may comprise prebiotics. If present, the prebiotic is preferably present in the infant formula in an amount 1 to 20wt %, preferably 2 to 15wt % on a dry matter basis.

A prebiotic is a non-digestible food ingredient that beneficially affects the host by selectively stimulating the growth and/or activity of one or a limited number of bacteria in the colon, and thus improves host health. Such ingredients are non-digestible in the sense that they are not broken down and absorbed in the stomach or small intestine and thus pass intact to the colon where they are selectively fermented by the beneficial bacteria. Examples of prebiotics include certain oligosaccharides, such as fructooligosaccharides (FOS) and galactooligosaccharides (GOS). A combination of prebiotics may be used such as 90% GOS with 10% short chain fructo-oligosaccharides such as the product sold under the trade mark Raftilose® or 10% inulin such as the product sold under the trade mark Raftiline®.

A particularly preferred prebiotic is a mixture of galacto-oligosaccharide(s), N-acetylated oligosaccharide(s) and sialylated oligosaccharide(s) in which the N-acetylated oligosaccharide(s) comprise 0.5 to 4.0% of the oligosaccharide mixture, the galacto-oligosaccharide(s) comprise 92.0 to 98.5% of the oligosaccharide mixture and the sialylated oligosaccharide(s) comprise 1.0 to 4.0% of the oligosaccharide mixture. This mixture is hereinafter referred to as “CMOS-GOS”.

Preferably, any of the infant formula of the array for the invention contain from 2.5 to 15.0 wt % CMOS-GOS on a dry matter basis with the proviso that the infant formula comprises at least 0.02 wt % of an N-acetylated oligosaccharide, at least 2.0 wt % of a galacto-oligosaccharide and at least 0.04 wt % of a sialylated oligosaccharide.

Suitable N-acetylated oligosaccharides include GalNAcαl,3Galβl,4Glc and Galβl,6GalNAcαl,3Galβl,4Glc. The N-acetylated oligosaccharides may be prepared by the action of glucosaminidase and/or galactosaminidase on N-acetyl-glucose and/or N-acetyl galactose. Bqually, N-acetyl-galactosyl transferases and/or N-acetyl-glycosyl transferases may be used for this purpose. The N-acetylated oligosaccharides may also be produced by fermentation technology using respective enzymes (recombinant or natural) and/or microbial fermentation. In the latter case the microbes may either express their natural enzymes and substrates or may be engineered to produce respective substrates and enzymes. Single microbial cultures or mixed cultures may be used. N-acetylated oligosaccharide formation can be initiated by acceptor substrates starting from any degree of polymerisation (DP) from DP=1 onwards. Another option is the chemical conversion of keto-hexoses (e.g. fructose) either free or bound to an oligosaccharide (e.g. lactulose) into N-acetylhexosamine or an N-acetylhexosamine containing oligosaccharide as described in Wrodnigg, T. M.; Stutz, A. E. (1999) Angew. Chem. Int. Ed. 38:827-828.

Suitable galacto-oligosaccharides include Galβ1, 6Gal, Galβ1, 6Galβ1, 4Glc, Galβ1, 6Galβ1, 6Glc, Galβ1, 3Galβ1, 3Glc, Galβ1,3Galβl,4Glc, Galβ1, 6Galβ1,6Galβ1,4Glc, Galβ1,6Galβ1,3Galβ1,4Glc, Galβ1,3Galβ1, 6Galβ1,4Glc, Galβ1, 3Galβ1,3Galβ1,4Glc, Galβ1,4Galβ1,4Glc and Galβ1,4Galβ1,4Galβ1,4Glc.

Synthesised galacto-oligosaccharides such as Galβ1, 6Galβ1, 4Glc, Galβ1, 6Galβ1, 6Glc, Galβ1,3Galβ1,4Glc, Galβ1,6Galβ1,6Galβ1,4Glc, Galβ1,6Galβ1,3Galβ1,4Glc and Galβ1,3Galβ1,6Galβ1,4Glc, Galβ1,4Galβ1,4Glc and Galβ1,4Galβ1,4Galβ1,4Glc and mixtures thereof are commercially available under the trademarks Vivinal® and Elix'or®. Other suppliers of oligosaccharides are Dextra Laboratories, Sigma-Aldrich Chemie GmbH and Kyowa Hakko Kogyo Co., Ltd. Alternatively, specific glycosyltransferases, such as galactosyltransferases may be used to produce neutral oligosaccharides.

Suitable sialylaled oligosaccharides include NeuAcα2,3Galβ1,4Glc and NeuAcα2,6Galβ1,4Glc. These sialylated oligosaccharides may be isolated by chromatographic or filtration technology from a natural source such as animal milks. Alternatively, they may also be produced by biotechnology using specific sialyltransferases either by enzyme based fermentation technology (recombinant or natural enzymes) or by microbial fermentation technology. In the latter case microbes may either express their natural enzymes and substrates or may be engineered to produce respective substrates and enzymes. Single microbial cultures or mixed cultures may be used. Sialyl-oligosaccharide formation can be initiated by acceptor substrates starting from any degree of polymerisation (DP) from DP=1 onwards.

The infant formula may optionally contain other substances which may have a beneficial effect such as nucleotides, nucleosides, and the like. Nucleotides may be selected from cytidine monophosphate (CMP), uridine monophosphate (UMP), adenosine monophosphate (AMP), guanosine monophosphate (GMP) or any mixtures thereof.

Any of the nutritional infant formula may also comprise at least one probiotic bacterial strain.

Examples of suitable probiotic micro-organisms include yeasts such as Saccharomyces, Debaromyces, Candida, Pichia and Torulopsis, moulds such as Aspergillus, Rhizopus, Mucor, and Penicillium and Torulopsis and bacteria such as the genera Bifidobacterium, Bacteroides, Clostridium, Fusobacterium, Melissococcus, Propionibacterium, Streptococcus, Enterococcus, Lactococcus, Staphylococcus, Peptostrepococcus, Bacillus, Pediococcus, Micrococcus, Leuconostoc, Weissella, Aerococcus, Oenococcus and Lactobacillus. Specific examples of suitable probiotic micro-organisms are: Saccharomyces cereviseae, Bacillus coagulans, Bacillus licheniformis, Bacillus subtilis, Bifidobacterium bifidum, Bifidobacterium infantis, Bifidobacterium longum, Enterococcus faecium, Enterococcus faecalis, Lactobacillus acidophilus, Lactobacillus alimentarius, Lactobacillus casei subsp. casei, Lactobacillus casei Shirota, Lactobacillus curvatus, Lactobacillus delbruckii subsp. lactis, Lactobacillus farciminus, Lactobacillus gasseri, Lactobacillus helveticus, Lactobacillus johnsonii, Lactobacillus rhamnosus (Lactobacillus GG), Lactobacillus sake, Lactococcus lactis, Micrococcus varians, Pediococcus acidilactici, Pediococcus pentosaceus, Pediococcus acidilactici, Pediococcus halophiles, Streptococcus faecalis, Streptococcus thermophilus, Staphylococcus carnosus, and Staphylococcus xyloses.

Preferred probiotic bacterial strains include Lactobacillus rhamnosus ATCC 53103 obtainable from Valio Oy of Finland under the trade mark LGG, Lactobacillus rhamnosus CGMCC 1.3724, Lactobacillus paracasei CNCM 1-2116, Bifidobacterium lactis CNCM 1-3446 sold inter alia by the Christian Hansen company of Denmark under the trade mark Bb 12 and Bifidobacterium longum ATCC BAA-999 sold by Morinaga Milk Industry Co. Ltd. of Japan under the trade mark BB536.

The amount of probiotic, if present, is preferably present in an amount of 10³ to 10¹² cfu/g, more preferably 10⁶ to 10¹¹ cfu/g, even more preferably 10⁴ to 10⁹ cfu/g, most preferably 10⁷ to 10⁹ cfu/g infant formula or per mL of infant formula. In one preferred embodiment, any of the nutritional infant formula of the array comprise 2×10⁷ cfu/g. Most preferably, the probiotic is Bifidobacterium lactis.

In an embodiment, the amount of probiotics present in the infant formula of the array may likewise preferably vary as a function of the age of the infant child.

The array of the invention aims to match closely the nutritional evolution curve of human breast milk, at least with respect to the protein, lactose, fat content and energy density.

Thus, in an embodiment, each of the first, second or the optionally third infant formula of the array of the invention is within at least 80%, preferably at least 90%, more preferably at least 95% of the average protein, lactose, fat content and energy density of human breast milk at the corresponding ages.

The nutritional infant formula may be prepared in any suitable manner. For example, an infant formula may be prepared by blending together a protein source, a carbohydrate source such as lactose, and a fat source in appropriate proportions. If used, emulsifiers may be included in the blend. The vitamins and minerals may be added at this point but are usually added later to avoid thermal degradation. Any lipophilic vitamins, emulsifiers and the like may be dissolved into the fat source prior to blending. Water, preferably water which has been subjected to reverse osmosis, may then be mixed in to form a liquid mixture.

The liquid mixture may then be thermally treated to reduce bacterial loads. For example, the liquid mixture may be rapidly heated to a temperature in the range of about 80° C. to about 110° C. for about 5 seconds to about 5 minutes. This may be carried out by steam injection or by heat exchanger; for example a plate heat exchanger.

The liquid mixture may then be cooled to about 60° C. to about 85° C. for example by flash cooling. The liquid mixture may then be homogenized for example in two stages at about 7 MPa to about 40 MPa in the first stage and about 2 MPa to about 14 MPa in the second stage. The homogenized mixture may then be further cooled to add any heat sensitive components such as vitamins and minerals. The pH and solids content of the homogenized mixture are conveniently standardized at this point.

The homogenized mixture is transferred to a suitable drying apparatus such as a spray drier or freeze drier and converted to powder. The powder should have a moisture content of less than about 3% by weight. Alternatively, the homogenized mixture is concentrated.

If it is desired to add probiotic(s), they may be cultured according to any suitable method and prepared for addition to the infant formula by freeze-drying or spray-drying for example. Alternatively, bacterial preparations can be bought from specialist suppliers such as Christian Hansen and Morinaga already prepared in a suitable form for addition to food products such as infant formula. Such bacterial preparations may be added to the powdered infant formula by dry mixing.

The capsules may be disposable capsules equipped with opening means contained within the capsule to permit draining of the reconstituted formula directly from the capsule into a receiving vessel such as a young child bottle. Such a method of using capsules for dispensing an infant or young child nutritional infant formula is described in WO2006/077259. The different nutritional infant formula forming part of the array of the invention may be packed into individual capsules and presented to the consumer in multipacks containing a sufficient number of capsules to meet the requirements of an infant for one week for example. Suitable capsule constructions are disclosed in WO2003/059778.

In one embodiment the invention is particularly adapted to fulfils the specific needs of a Chinese population of infants and/or infant having an asian genetic background. In one embodiment the invention is specifically adapted to populations having similar “Chinese-type” of dietary habits. In one embodiment the invention promotes the most adapted growth and/or most adapted development of the immune, neuronal and/or gastro-intestinal functions, especially in the said populations.

The present invention is further illustrated hereinafter by means of the following non-limiting examples.

### EXAMPLES

### Example 1

An array of age-tailored infant formula is given in the table below, wherein energy density means energy of 100 ml standard milk liquid consisting of 13.08 g infant formula and 90 ml water:

| | | | | 6 to 12 |
|---|---|---|---|---|
| | Age range | 0 to 3 months | 3 to 6 months | months |
| Basics | Reconstitution | 100 to 200 | 100 to 200 | 230 |
| | RTD Volume (ml) | | | |
| | Energy density | 63-67 | 63-67 | 63 |
| | (kcal/100 ml) | | | |
| Protein | Content | 1.9 to 2.9 | 1.9 to 2.9 | 1.9 |
| | (g/100 kcal) | | | |
| | Content (g/l) | 11.1 to 17.1 | 11.1 to 17.1 | 11.1 |
| | Whey:Casein | 70:30 | 70:30 | 50:50 |
| | Functional | . | . | |
| | proteins | | | |
| Carbohydrates | Type | Lactose | Lactose | Lactose |
| | Content | 9.2 to 13.8 | 9.2 to 13.8 | 10.6 |
| | (g/100 kcal) | | | |
| | Content (g/l) | 54.0 to 81.2 | 54.0 to 81.2 | 62.3 |
| Lipids | Type | Milk&Veg. | Milk & Veg. | Milk & |
| | | | | Veg. |
| | Content | 4.4 to 5.8 | 4.4 to 5.8 | 5.6 |
| | (g/100 kcal) | | | |
| | content (as % | 45.9 to 52.2 | 45.9 to 52.2 | 45.8 |
| | of total | | | |
| | energy) | | | |
| | Content (g/l) | 25.8 to 34.0 | 25.8 to 34.0 | 32.8 |
| | LC-PUFA | DHA + ARA | DHA + ARA | DHA + ARA |
| Soluble | Content | | | |
| Fibers | (g/100 kcal) | | | |
| Probiotics | Type | B. lactis | B. lactis or | |
| | | | B. Longum ATCC | |
| | | | BAA-999 | |
| | Content | 2 × 10⁷ cfu/g | 2 × 10⁷ cfu/g | |
| | | | or 10⁹ cfu/g | |
| Nucleotides | CMP (mg/100 kcal) | 1.1 | 1.1 | — |
| | UMP | 0.7 | 0.7 | — |
| | AMP | 0.7 | 0.7 | — |
| | GMP | 0.2 | 0.2 | — |
| | NucleoPremix | | | — |
| Minerals | Na (mg) | 40 | 24 | 21 |
| (/100 kcal) | K (mg) | 105 | 81 | 70 |
| | Na/K (molar | 0.65 | 0.5 | 0.5 |
| | ratio) | | | |
| | (Na + K)/Cl molar | 1.71 to 1.81 | 1.71 to 1.81 | 1.71 |
| | ratio | | | |
| | Cl (mg) | 87 to 92 | 61 to 65 | 56 |
| | Ca (mg) | 100 | 97 | 90 |
| | P (mg) | 47 | 42 | 37 |
| | Mg (mg) | 7 | 7 | 7 |
| | Mn (μg) | 5 | 5 | 5 |
| | Ca/P | 2.13 | 2.31 | 2.43 |
| | Fe (mg) | 0.7 | 0.7 | 1 |
| | I (μg) | 25 | 15 | 13 |
| | Cu (μg) | 100 | 60 | 53 |
| | Zn (mg) | 1.2 | 0.65 | 0.55 |
| | Se (μg) | 3 to 4 | 3 to 4 | 3 |
| | F (μg) | | | — |
| Vitamins | Vit. A (mg RE) | 0.09 to | 0.09 to | 0.09 |
| (/100 kcal) | | 0.1125 | 0.1125 | |
| | Beta carotene | | | |
| | (μg) | | | |
| | Vit. D (mg) | 0.0015 | 0.0015 | 0.0015 |
| | Vit. E (mg) | 1.3 | 1.3 | 1.3 |
| | Vit. K1 (μg) | 8 | 8 | 8 |
| | Vit. C (mg) | 15 | 15 | 15 |
| | Vit. B1 (mg) | 0.07 to 0.1 | 0.07 to 0.1 | 0.1 |
| | Vit. B2 (mg) | 0.1 | 0.1 | 0.1 |
| | Niacin (mg) | 0.5 | 0.5 | 0.5 |
| | Vit. B6 (mg) | 0.05 | 0.05 | 0.05 |
| | Folic acid (μg) | 15 to 16 | 15 to 16 | 15 |
| | Pantothenic | 0.7 to 0.8 | 0.7 to 0.8 | 0.8 |
| | Acid (mg) | | | |
| | Vit. B12 (μg) | 0.2 | 0.2 | 0.2 |
| | Biotin (μg) | 2 | 2 | 2 |
| | Choline (mg) | 20 | 20 | 20 |
| | Inositol (mg) | 25 | 25 | 20 |
| | Taurine (mg) | 8 | 8 | 6 |
| | Carnitine (mg) | 1.5 | 1.5 | — |

### Example 2

An array of age-tailored infant formula is given in the table below:

| | 0 to 3 | 3 to 6 | 6 to 12 |
|---|---|---|---|
| | months | months | months |
| Nutrient | per 100 kcal | per 100 kcal | per 100 kcal |
| Energy (kcal) | 100 | 100 | 100 |
| Protein (g) | 2 | 2.3 | 2.0 |
| Fat (g) | 5.6 | 5.3 | 5.1 |
| Linoleic acid (g) | 0.79 | 0.79 | 0.79 |
| α-Linolenic acid | 101 | 101 | 101 |
| (mg) | | | |
| Lactose (g) | 13.2 | 12.8 | 11.2 |
| Minerals (g) | 0.37 | 0.37 | 0.37 |
| Na (mg) | 40 | 23 | 21 |
| K (mg) | 100 | 80 | 75 |
| Cl (mg) | 64 | 64 | 64 |
| Ca (mg) | 100 | 96 | 92 |
| P (mg) | 46 | 41 | 37 |
| Ca/P ratio | 2.17 | 2.34 | 2.48 |
| Mg (mg) | 7 | 7 | 7 |
| Mn (μg) | 8 | 8 | 8 |
| Se (μg) | 2 | 2 | 2 |
| Vitamin A (μg RE) | 105 | 105 | 105 |
| Vitamin D (μg) | 1.5 | 1.5 | 1.5 |
| Vitamin E (mg TE) | 0.8 | 0.8 | 0.8 |
| Vitamin K1 (μg) | 8 | 8 | 8 |
| Vitamin C (mg) | 10 | 10 | 10 |
| Vitamin B1 (mg) | 0.07 | 0.07 | 0.07 |
| Vitamin B2 (mg) | 0.15 | 0.15 | 0.15 |
| Niacin (mg) | 1 | 1 | 1 |
| Vitamin B6 (mg) | 0.075 | 0.075 | 0.075 |
| Folic acid (μg) | 9 | 9 | 9 |
| Pantothenic acid | 0.45 | 0.45 | 0.45 |
| (mg) | | | |
| Vitamin B12 (μg) | 0.3 | 0.3 | 0.3 |
| Biotin (μg) | 2.2 | 2.2 | 2.2 |
| Choline (mg) | 10 | 10 | 10 |
| Fe (mg) | 1.2 | 1.2 | 1.2 |
| I (μg) | 24 | 15 | 13 |
| Cu (μg) | 95 | 60 | 54 |
| Zn (mg) | 1.25 | 0.65 | 0.58 |
| 3′sialyllactose | 30 | 30 | 30 |
| (mg) | | | |
| 6′sialyllactose (mg) | 6 | 6 | 6 |
| LNnT (mg) | 30 | 30 | 30 |
| 2FL (g) | 0.3 | 0.3 | 0.3 |

It was shown that feeding an array of nutritional infant formula as exemplified above, the dietary need of infants children were met, in particular with regards to protein, lactose, fat and energy. Also, the infant formula were a close match of human breast milk at the different ages.

1. An array of infant formula for providing an age-tailored nutrition system to an infant, comprising a first infant formula for infants between 0 to 3 months, and a second infant formula for infants between 3 to 6 months wherein
the content of protein in the second infant formula is lower than in the first infant formula; and
the content of lactose in the second infant formula is higher than in the first infant formula.

2. The array of infant formula according to claim 1, wherein:
the first infant formula comprises a protein content of between 1.9 and 2.9 g/100 kcal and a lactose content of between 9.2 and 13.8 g/100 kcal; and
the second infant formula comprises a protein content of between 1.9 and 2.9 g/100 kcal and a lactose content of between 9.2 and 13.8 g/100 kcal.

3. The array of infant formula according to claim 1, wherein the energy density in the second infant formula is lower than in the first infant formula,
the first infant formula comprises an energy density of between 63 and 67 kcal/100 ml,
the second infant formula comprises an energy density of between 63 and 67 kcal/100 ml.

4. The array of infant formula according to claim 1, wherein:
the first infant formula comprises a fat content of between 4.4 and 5.8 g/100 kcal; and,
the second infant formula comprises a fat content of between 4.4 and 5.8 g/100 kcal.

5. The array of infant formula according to claim 1,
wherein each of the first and second infant formulas comprise suitable amounts of mineral nutrients selected from the group consisting of calcium, iodine, phosphorus, potassium, sodium, copper and zinc,
wherein the content of at least one of the mineral nutrients in the second infant formula is lower than in the first infant formula.

6. The array of infant formula according to claim 5, wherein the contents of at least two of the mineral nutrients in the second infant formula are lower than in the first infant formula.

7. The array of infant formula according to claim 5, wherein the contents of iodine, phosphorus, potassium, sodium, copper and zinc in the second infant formula are lower than in the first infant formula.

8. The array of infant formula according to claim 5, wherein the contents of calcium, iodine, phosphorus, potassium, sodium, copper and zinc in the second infant formula are lower than in the first infant formula.

9. The array of infant formula according to claim 5, wherein the content of iodine in the first infant formula is from 50.0m/100 kcal to 16.5 μg/100 kcal, and the content of iodine in the second infant formula is from 16.5 μg/100 kcal to 14.0 μg/100 kcal.

10. The array of infant formula according to claim 5, wherein the content of phosphorus in the first infant formula is from 70 mg/100 kcal to 42 mg/100 kcal, and the content of phosphorus in the second infant formula is from 42 mg/100 kcal to 38 mg/100 kcal.

11. The array of infant formula according to claim 5, wherein the content of potassium in the first infant formula is from 170 mg/100 kcal to 85 mg/100 kcal, and the content of potassium in the second infant formula is from 85 mg/100 kcal to 80 mg/100 kcal.

12. The array of infant formula according to claim 5, wherein the content of sodium in the first infant formula is from 58 mg/100 kcal to 25 mg/100 kcal, and the content of sodium in the second infant formula is from 25 mg/100 kcal to 22 mg/100 kcal.

13. The array of infant formula according to claim 5, wherein the content of copper in the first infant formula is from 120 μg/100 kcal to 62 μg/100 kcal, and the content of copper in the second infant formula is from 62 μg/100 kcal to 55 μg/100 kcal.

14. The array of infant formula according to claim 5, wherein the content of zinc in the first infant formula is from 1.5 mg/100 kcal to 0.7 mg/100 kcal, and the content of zinc in the second infant formula is from 0.7 mg/100 kcal to 0.6 mg/100 kcal.

15. The array of infant formula according to claim 5, wherein the content of calcium in the first infant formula is from 140 mg/100 kcal to 98 mg/100 kcal, and the content of calcium in the second infant formula is from 98 mg/100 kcal to 95 mg/100 kcal.

16. The array of infant formula according to claim 5, wherein: the ratio of calcium and phosphorus in the first infant formula is lower than in the second infant formula;
the ratio of calcium and phosphorus in the first infant formula is from 2.0:1 to 2.2:1; and
the ratio of calcium and phosphorus in the second infant formula is from 2.2:1 to 2.4:1.

17. The array of infant formula according to claim 5, wherein each of the first and the second infant formula comprises long-chain polyunsaturated fatty acids selected from the group consisting of docosahexaenoic acid, arachidonic acid, eicosapentaenoic acid, and/or comprises medium-chain triglycerides and/or milk fat globule membranes, and mixtures thereof.

18. The array of infant formula according to claim 5, wherein each of the first and the second infant formulas comprise a component selected from the group consisting of vitamins, lactoferrin, probiotics, prebiotics, proteins associated with milk fat globule membrane (MFGM), hydrolysed or non-hydrolysed protein, carbohydrates, maltodextrin, and mixtures thereof.

19. The array of infant formula according to claim 18, wherein the probiotics in the first and second infant formula are selected from the group consisting of L. helveticus CNCM 1-4095, B. longum CNCM 1-2618, B. breve NCC2950, L. paracasei ST11 CNCM 1-2116, B. longum BB536 ATCC BAA-999, B. Longum BL999, L. acidophilus L92 FERM BP.4981 or any mixtures thereof.

20. The array of infant formula according to claim 1, wherein the first infant formula has a protein source comprising whey proteins and a protein content between 1.9 and 2.9 g protein/100 kcal, and the second infant formula has a protein source comprising whey and casein proteins and has a whey:casein ratio between 70:30 and 50:50 and a protein content between 1.9 and 2.9 g protein/100 kcal with the proviso that either the protein content or the whey:casein ratio of the second formula or both is/are lower than for the first formula.

21. The array of infant formula according to claim 1, wherein each of the first and the second infant formulas are in the form of a powder to be reconstituted or a concentrate to be diluted.

22. The array of infant formula according to claim 1, wherein the first and the second infant formula are packed in single dose units, each unit comprising sufficient nutritional composition to prepare a single serving upon reconstitution with water.

23. The array of infant formula according to claim 22, wherein the single dose units are in a form of a capsule or a can.

24. A method for use in improving the nutritional condition of an infant from 0 to 6 months comprising administering an array of infant formula for providing an age-tailored nutrition system to an infant, comprising a first infant formula for infants between 0 to 3 months, and a second infant formula for infants between 3 to 6 months, wherein
the content of protein in the second infant formula is lower than in the first infant formula; and
the content of lactose in the second infant formula is higher than in the first infant formula to the infant.

25. (canceled)

26. A method of providing nutrition to an infant, comprising:
feeding to the infant for initial three months of life the first infant formula for providing an age-tailored nutrition system to an infant, comprising a first infant formula for infants between 0 to 3 months, and a second infant formula for infants between 3 to 6 months, wherein
the content of protein in the second infant formula is lower than in the first infant formula; and
the content of lactose in the second infant formula is higher than in the first infant formula; and
feeding to the infant for the remainder of the first six months of life the second infant formula.

27. A method for reducing obesity or diabetes or the risk thereof later in life and in reducing cardiovascular diseases or the risk thereof later in life comprising administering an array of infant formula for providing an age-tailored nutrition system to an infant, comprising a first infant formula for infants between 0 to 3 months, and a second infant formula for infants between 3 to 6 months, wherein
the content of protein in the second infant formula is lower than in the first infant formula; and
the content of lactose in the second infant formula is higher than in the first infant formula to the infant.

28. An array of infant formula for providing an age-tailored nutrition system to an infant, comprising a first infant formula between 0 to 3 months, a second infant formula between 3 to 6 months, and a third infant formula between 6 to 12 months, wherein:
the content of protein in the second infant formula is lower than in the first infant formula;
the content of lactose in the second infant formula is higher than in the first infant formula;
the content of protein in the third infant formula is lower than in the second infant formula; and
the content of lactose in the third infant formula is higher than in the second infant formula.
